(19) United States
(12) Patent Application Publication
(10) Pub. No.: US 2025/0193702 A1
(43) Pub. Date: Jun. 12, 2025

(54) 5G NR BASE STATION SYSTEM SUPPORTING IN-BAND WIRELESS BACKHAUL

(71) Applicant: EUCAST CO., LTD., Seongnam-si (KR)

(72) Inventor: Dong Kwan LEE, Seongnam-si (KR)

(21) Appl. No.: 18/974,981

(22) Filed: Dec. 10, 2024

(30) Foreign Application Priority Data
Dec. 12, 2023 (KR) 10-2023-0179517

(51) Int. Cl. H04W 24/02; H04B 17/318

(52) U.S. Cl. CPC H04W 24/02; H04B 17/328

(57) ABSTRACT

The present disclosure relates to a 5G NR base station system which supports wireless backhaul in a band. Disclosed is a method for installing a plurality of small cell base stations to support a 5G communication service inside a building, including: operating, by all small cell base stations possible to perform a wired backhaul connection among a plurality of small cell base stations, as Type A base stations and operating, by all small cell base stations possible for accessing the Type A base station through a wireless backhaul terminal among the plurality of small cell base stations, as one-hop Type B base stations.

### CROSS REFERENCE TO RELATED APPLICATION

The present application claims priority to Korea Patent Application No. 10-2023-0179517, filed Dec. 12, 2023, the entire contents of which is incorporated herein for all purposes by this reference.

### FIELD

The present disclosure relates to a 5G NR base station system, more particularly, to a 5G NR base station system which supports in-band wireless backhaul.

### BACKGROUND

As backhaul of a base station in a mobile communication system, wireless technologies such as an optical link and the like are used in general. However, according to an environment of installation, when the wired link is hard to be installed or expenses are consumed a lot, the wireless backhaul may be considered.

In a 5G mobile communication environment, communication technologies in a manner other than that of the 5G system may be used, but in consideration of the transmission speed and expenses, it may be promising to use the 5G system as a wireless backhaul, as well as using it as the wireless access. In particular, a beam forming technology is aggressively used in the 5G system, and it may be more advantageous to utilize the 5G system as the wireless backhaul.

The most serious problem in the wireless backhaul of the mobile communication system is interference between a base station and a terminal for backhaul. In particular, it is difficult to secure sufficient performance only through removal of interference using a filter when an access frequency of the mobile communication system and the backhaul frequency are near to each other. In order to avoid the problem, time may be divided and used such that times of use of the access system and the backhaul system do not overlap each other. However, such a time division method has a problem that the method is ineffective in terms of resource utilization because only part of the entire time resources is used.

### SUMMARY

Embodiments of the present disclosure aim to provide a 5G NR base station system which support in-band wireless backhaul, which can use the entire resource to the fullest, while avoiding interference by properly conducting time-division of the access system and the backhaul system.

One embodiment is a method of operating a plurality of small cell base stations to support a 5G communication service, the method including: operating, by all small cell base stations possible to perform a wired backhaul connection among a plurality of small cell base stations, as Type A base stations and operating, by all small cell base stations possible for accessing the Type A base station through a wireless backhaul terminal among the plurality of small cell base stations, as one-hop Type B base stations.

The method may further include operating, by all small cell base stations possible for accessing the one-hop Type B base station through a wireless backhaul terminal among the plurality of small cell base stations, as two-hop Type B base stations and setting, by small cell base stations which do not belong to the Type A base station, the one-hop Type B base station, and the two-hop Type B base station among the plurality of small cell base stations, as uninstallable small cell base stations.

The operating by all small cell base stations possible to perform a wired backhaul connection among a plurality of small cell base stations as Type A base stations comprises determining, by each of the plurality of small base stations, whether the each of the plurality of small cell base stations are possible to perform a wired backhaul connection and setting, by each of the plurality of small cell base stations determined to be possible to perform a wired backhaul connection to operate, as Type A base stations.

The operating, by all small cell base stations possible for accessing the Type A base station through a wireless backhaul terminal among the plurality of small cell base stations, as one-hop Type B base stations comprises receiving, by each of the small cell base stations which do not operate as the Type A base station among the plurality of small cell base stations, a reference signal sent from at least one of the Type A base stations using a wireless backhaul terminal, determining, by each of the small cell base stations which do not operate as the Type A base station among the plurality of small cell base stations, whether at least one among RSRPs (reference signals received power) of the reference signal received from at least one of the Type A base stations is in a preset range, accessing, by each of the small cell base stations which do not operate as the Type A base station and at least one among RSRPs of the received reference signal is in a preset range, a Type A base station which sent a reference signal indicating a RSRP in a preset range using the wireless backhaul terminal and operating, by each of the small cell base stations which accesses a Type A base station using the wireless backhaul terminal, as the one-hop Type B base station.

The operating, by all small cell base stations possible for accessing the one-hop Type B base station through a wireless backhaul terminal among the plurality of small cell base stations, as two-hop Type B base stations comprises receiving, by each of the small cell base stations which do not operate as the Type A base station and the one-hop Type B base station among the plurality of small cell base stations, a reference signal sent from at least one of the one-hop Type B base stations using a wireless backhaul terminal, determining, by each of the small cell base stations which do not operate as the Type A base station and the one-hop Type B base station among the plurality of small cell base stations, whether at least one among RSRPs of a reference signal received from at least one of the one-hop Type B base stations is in a preset range, accessing, by each of the small cell base stations which do not operate as the Type A base station and the one-hop Type B base station and at least one among RSRPs of the received reference signal is in a preset range, the one-hop Type B base station which sent a reference signal indicating a RSRP in a preset range using the wireless backhaul terminal and operating, by each of the small cell base station which accesses a one-hop Type B base station using the wireless backhaul terminal, as the two-hop Type B base station.

The operating, by all small cell base stations possible for accessing the Type A base station through a wireless backhaul terminal among the plurality of small cell base stations, as one-hop Type B base stations comprises receiving, by each of the small cell base stations which do not operate as the Type A base station among the plurality of small cell base stations, a reference signal sent from at least one of the Type A base stations using a wireless backhaul terminal, determining, by each of the small cell base stations which do not operate as the Type A base station among the plurality of small cell base stations, whether at least one among RSRPs of a reference signal received from at least one of the Type A base stations is in a preset range and whether a base station parameter comprised in the reference signal indicates that a wired backhaul connection is done, accessing, by each of the small cell base stations which do not operate as the Type A base station, RSRP of the received reference signal from a first Type A base station is in a preset range and a base station parameter comprised in the received reference signal from the first Type A base station indicates that a wired backhaul connection is done, the first Type A base station using the wireless backhaul terminal and operating, by each of the small cell base station which accesses the first Type A base station using the wireless backhaul terminal, as the one-hop Type B base station.

The operating, by all small cell base stations possible for accessing the one-hop Type B base station through a wireless backhaul terminal among the plurality of small cell base stations, as two-hop Type B base stations comprises receiving, by each of the small cell base stations which do not operate as the Type A base station and the one-hop Type B base station among the plurality of small cell base stations, a reference signal sent from at least one of the one-hop Type B base stations using a wireless backhaul terminal, determining, by each of the small cell base stations which do not operate as the Type A base station and the one-hop Type B base station among the plurality of small cell base stations, whether at least one among RSRPs of a reference signal received from at least one of one-hop Type B base stations is in a preset range and whether a base station parameter comprised in the reference signal indicates that a wired backhaul connection is done, accessing, by each of the small cell base stations which do not operate as the Type A base station, RSRP of the received reference signal from a first one-hop Type B base station is in a preset range and a base station parameter comprised in a reference signal received from the first one-hop Type B base station indicates that a wired backhaul connection is done, the first one-hop Type B base station using the wireless backhaul terminal and operating, by each of the small cell base station which accesses the first one-hop Type B base station using the wireless backhaul terminal as the two-hop Type B base station.

In addition, small cell base stations operating as the Type A base stations and the two-hop Type B base stations are set to use an identical first TDD (time division duplex) pattern for downlink data transmission and uplink data transmission, and small cell base stations operating as the one-hop Type B base stations are set to use a second TDD pattern, which indicates uplink data transmission when the first TDD pattern indicates downlink data transmission, and which indicates downlink data transmission when the first TDD pattern indicates uplink data transmission. Another embodiment is a method for setting an operation type of a small cell base station, the method including determining whether a wired backhaul connection is possible, setting, when a wired backhaul connection is possible, the small cell base station to operate as a Type A base station, receiving, when a wired backhaul connection is not possible, a first reference signal of a small cell base station operating as a Type A base station using a connected wireless backhaul terminal, determining whether RSRP (reference signals received power) of the received first reference signal is in a preset range, setting, when RSRP of the received first reference signal is in a preset range, the small cell base station to operate as a one-hop Type B base station, receiving, when RSRP of the received first reference signal is out of a preset range, a second reference signal of a base station operating as a one-hop Type B base station using the connected wireless backhaul terminal, determining whether RSRP of the received second reference signal is in a preset range and setting, when RSRP of the received second reference signal is in a preset range, the small cell base station to operate as a two-hop Type B base station.

Still another embodiment is a method for setting an operation type of a small cell base station, the method including determining whether a wired backhaul connection is possible, setting, when a wired backhaul connection is possible, the small cell base station to operate as a Type A base station, receiving, when a wired backhaul connection is not possible, a first reference signal of a small cell base station operating as a Type A base station using a connected wireless backhaul terminal, determining whether RSRP (reference signals received power) of the received first reference signal is in a preset range and whether a first base station parameter comprised in the first reference signal indicates that a wired backhaul connection is done, setting, when RSRP of the received first reference signal is in a preset range and the first base station parameter indicates that a wired backhaul connection is done, the small cell base station to operate as a one-hop Type B base station, receiving, when RSRP of the received first reference signal is out of a preset range or the base station parameter indicates that a wired backhaul connection is not done, a second reference signal of a base station operating as a one-hop Type B base station using the connected wireless backhaul terminal, determining whether RSRP of the received second reference signal is in a preset range and whether a second base station parameter comprised in the second reference signal indicates that a wired backhaul connection is done and setting, when RSRPs of the received second reference signal is in a preset range and the second base station parameter indicates that a wired backhaul connection is done, the small cell base station to operate as a two-hop Type B base station.

Embodiments of the present disclosure may configure wireless backhaul of the 5G NR base station easily by using the 5G communication protocol for the purpose of the backhaul data transmission.

### BRIEF DESCRIPTION OF THE DRAWINGS

FIG. 1 is a view illustrating an example of a small cell system configuration using wireless backhaul according to the present disclosure.

FIGS. 2 and 3 are views illustrating TDD setting examples of a Type A base station and a Type B base station, capable of preventing interference between a Type B base station and a backhaul terminal based on various embodiments of the present disclosure.

FIG. 4 is a view illustrating an example of implementing wireless backhaul using a two-hop relay.

FIG. 5 is a flowchart illustrating a method for installing a plurality of small cell base stations in order to implement 5G communication to be made possible in a building.

FIG. 6 is a flowchart illustrating a method of a small cell base station for selecting an own operation type.

### DETAILED DESCRIPTION

Advantages and characteristics of the present disclosure and a method of achieving the advantages and characteristics will be clear by referring to exemplary embodiments described below in detail together with the accompanying drawings. However, the present disclosure is not limited to exemplary embodiment disclosed herein but will be implemented in various forms. The exemplary embodiments are provided by way of example only so that a person of ordinary skilled in the art can fully understand the disclosures of the present disclosure and the scope of the present disclosure. Therefore, the present disclosure will be defined only by the scope of the appended claims. Like reference numerals generally denote like elements throughout the specification.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. The term “and/or” includes any and all combinations of one or more of the associated listed items.

The terms used in the present specification are merely used to describe specific embodiments and are not intended to limit the present invention. A singular expression includes a plural expression unless a description to the contrary is specifically pointed out in context. Components, steps, operations and/or elements that are referred to by terms “comprises” and/or “comprising” used in the inventive concept do not exclude presence or addition of one or more other components, steps, operations and/or elements.

Although the terms “first”, “second”, and the like are used for describing various components, these components are not confined by these terms. These terms are merely used for distinguishing one component from the other components.

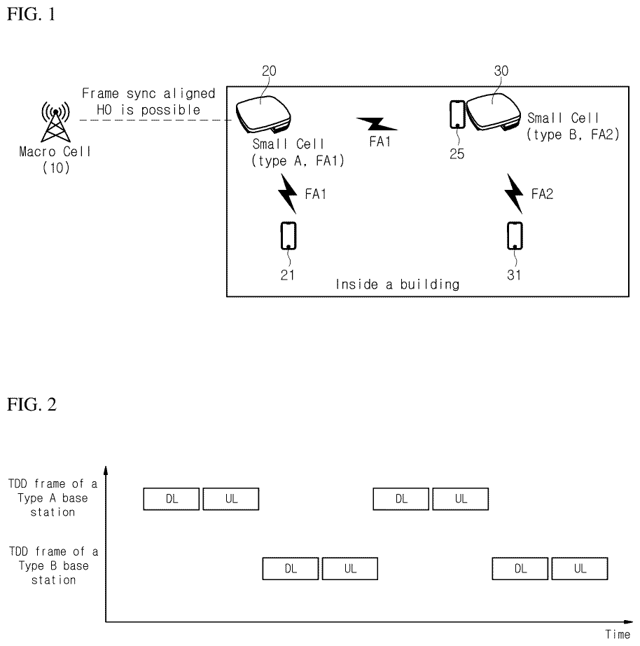

FIG. 1 is a view illustrating an example of a small cell system configuration using wireless backhaul according to the present disclosure.

Referring to FIG. 1, a Type A base station 20 is a general small cell which is synchronized with the existing 5G system, is able to perform the same function as that of the existing 5G system, and frame synchronization thereof is matched, and therefore, the Type A base station 20 may implement handover of an access terminal 21, which is an access UE, between a macro cell base station 10 for the existing 5G system and the Type A base station 20. In case of the Type A base station 20, the wired technology may be used with the backhaul like a case of the macro cell base station 10.

A Type B base station 30 is a 5G small cell base station using wireless backhaul, and the wireless backhaul connection may be obtained through a backhaul terminal 25, which is a backhaul UE, connected to the Type A base station 20 in a form of an access terminal.

In an example of FIG. 1, the Type A base station 20 performs data communication with terminals using a frequency FA1, and a terminal 21 and a terminal 25 may be connected thereto as access terminals. On contrary, the Type B base station performs data communication with terminals using a frequency FA2, and a terminal 31 may be connected thereto as an access terminal. In addition, the terminal 25 used as a wireless backhaul terminal of the Type B base station 30 and the Type B base station 30 are connected by a wired technology or the terminal 25 may be provided as a component inside the Type B base station 30. According to another embodiment, the Type B base station 30 and the backhaul terminal 25 may be connected by other kinds of a near field wireless communication method, not by the 5G communication method. Data received and sent by/from all access terminals 31 which are connected to the Type B base station 30 must pass through the backhaul terminal 25, and even if they are connected in the wireless communication method, the backhaul terminal 25 and the Type B base station 30 need to improve the data transmission speed by positioning themselves at places which are very close to each other.

Likewise, in a state in which the backhaul terminal 25 and the Type B base station 30 exist at places close to each other, or are provided inside one device, when a transmission time point of the backhaul terminal 25 and a reception time point of the Type B base station 30 overlap each other, transmission power of the backhaul terminal 25 influences the Type B base station 30 with interference in a large quantity, thereby seriously influencing the reception performance of the Type B base station 30. In addition, when a transmission section of the Type B base station 30 and a reception section of the backhaul terminal 25 overlap each other, a reception signal of the Type B base station 30 may cause interference, thereby greatly influencing the downlink reception of the backhaul terminal 25.

Therefore, the Type B base station 30 needs to perform TDD setting based on TDD (time division duplex) setting of the Type A base station 25 so that the above-described situations do not occur. To describe it in more detail, a DL (downlink) section transmitting data from the Type A base station 20 to the backhaul terminal 25 and the DL section of the Type B base station 30 must not overlap each other, and a UL (uplink) section through which the Type A base station 20 may receive data from the backhaul terminal 25 and a UL section of the Type B base station 30 must not overlap each other.

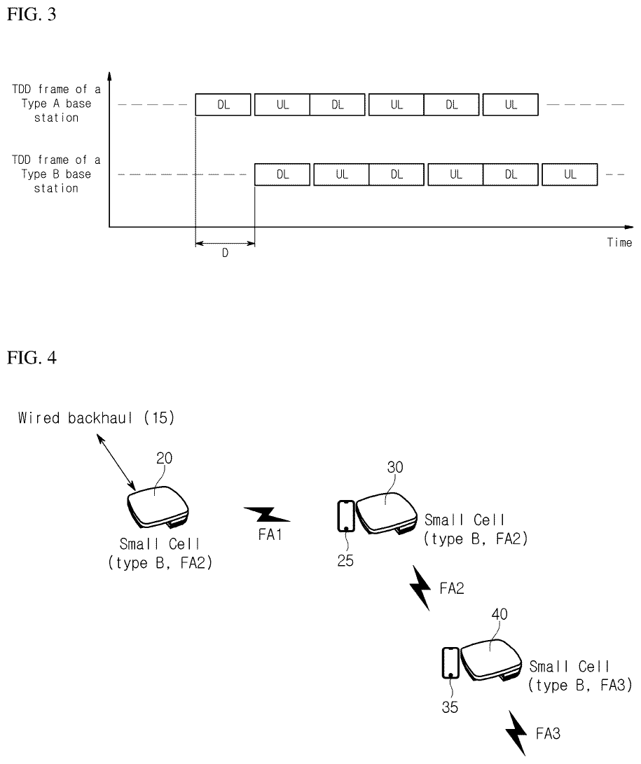

FIGS. 2 and 3 are views illustrating TDD setting examples of the Type A base station and the Type B base station, capable of preventing interference between the Type B base station and the backhaul terminal based on various embodiments of the present disclosure.

According to an embodiment, as illustrated in FIG. 2, when temporally separating the DL/UL operation sections of the Type A base station 20 and the DL/UL operation sections of the Type B base station 30 to the fullest, the above-described problems may be solved, however, each base station uses only half of the entire time sources, therefore, the above method cannot result in effective operation.

According to another embodiment, as illustrated in FIG. 3, it is possible to hold up a time to start a frame of the Type B base station 30 by as much as a certain time delay D, compared to a time to start a frame of the Type A base station 20. According to an embodiment, it is possible to allow the DL section of the Type A base station 20, which is a reception section of the backhaul terminal 25, to only overlaps a TDD gap section, which is a section set for interference-free switchover between the DL section and the UL section, and the UL section of the Type B base station 30. Similarly, it is possible to set the transmission section of the Type B base station 30 to only overlaps the TDD gap section and the UL section of the Type A base station, which is a transmission section of the backhaul terminal 25. To put it simply, it is possible to solve the above-described interference problem by a large part, by setting the TDD such that the transmission section of the backhaul terminal 25 overlaps the transmission section of the Type B base station 30 to the fullest, and the reception section of the backhaul terminal 25 overlaps the reception section of the Type B base station 30 to the fullest.

The above-description based on FIG. 1 is explanation of a wireless backhaul using a one-hop relay. That is, the above-description based on FIG. 1 is about a case where a base station to which the backhaul terminal 25 is connected is a Type A base station 20 which uses the wired technology as the backhaul. In addition, the wireless backhaul using a relay configured with two-hops or more may be possible for the above-description based on FIG. 1.

FIG. 4 is a view illustrating an example of implementing wireless backhaul using a two-hop relay.

Referring to FIG. 4, a Type B base station 40 which implements the wireless backhaul using the backhaul terminal 25 transmits data to another Type B base station 30, and the Type B base station 30 implements the wireless backhaul using the backhaul terminal 25 as well, thereby the Type B base station 30 is connected to the Type A base station 20 connected to a wired backhaul 15. That is, the wireless backhaul of the Type B base station 40 may be the wireless backhaul in a two-hop relay form which passes through two wireless networks and connected to the wired backhaul 15. A backhaul terminal 35 of the Type B base station 40 is at a position which cannot be connected to the Type A base station 20 directly, therefore, the backhaul terminal 35 is connected to another Type B base station 30 in-between, thereby connecting the Type B base station 40 to the wired backhaul 15. The wireless backhaul may pass through the relay of two or more hops and then, may be connected to the wired backhaul 15 finally.

In this case, the TDD setting as illustrated in FIG. 3 may need to be performed so as to prevent interference not only between the Type A base station 20 and the Type B base station 30, but also between the Type B base station 30 and the Type B base station 40. According to an embodiment, when the TDD setting as illustrated in FIG. 3 is performed not only between the Type A base station 20 and the Type B base station 30, but also between the Type B base station 30 and the Type B base station 40, the Type A base station 20 and the Type B base station 40 may have the same TDD setting.

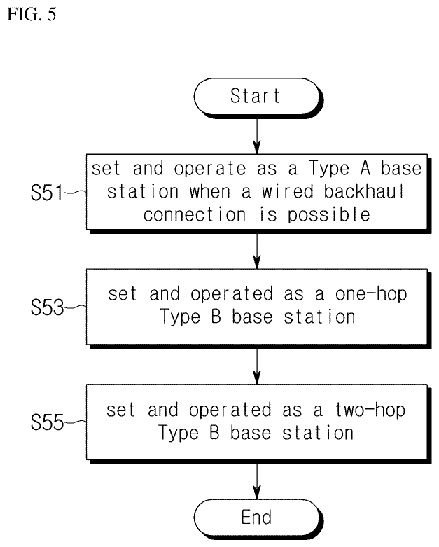

FIG. 5 is a flowchart illustrating a method for installing a plurality of small cell base stations in order to implement 5G communication to be made possible in a building.

In order to implement 5G communication to be made possible in a building, a plurality of small cell base stations may be installed. At this instance, the small cell base stations may be set and operated as a Type A base station, to which the wired backhaul can be connected, or a Type B base station, to which the wireless backhaul can be connected.

Referring to FIG. 5G, in an operation S51, each of the plurality of base stations may figure out whether a wired backhaul connection is possible at a position at which the corresponding base station must be installed, and may be set and operated as a Type A base station when the wired backhaul connection is possible.

According to an embodiment, the small cell base stations 20, 30 and 40 may determine that the wired backhaul connection is possible when optical connection, WiFi connection, or Ethernet connection are implemented physically and connection to a core network is possible. In addition, the small cell base stations 20, 30 and 40 may determine that the wired backhaul connection is not possible when any one among the optical connection, WiFi connection, and Ethernet connection, which make the wired connection possible, is not implemented, or connection to the core network is not implemented.

When the wired backhaul connection is possible and the Type A base station setting is completed for all the small cell base stations, which can operate as a Type A base station, a one-hop Type B base station may be set and operated in an operation S53.

Each of the small cell base stations which cannot operate as a Type A base station, because the wired backhaul connection is impossible, may attempt access to a Type A base station, which operates using a wireless backhaul terminal connected to itself.

When the backhaul terminal receives a signal of the Type A base station too strongly, a problem of cell overlap may occur, and when the backhaul terminal receives a signal of the Type A base station too weakly, a problem of too slow backhaul transmission speed may occur. Therefore, with respect to a signal coming from the Type A base station, when a RSRP (reference signals received power) measured at the wireless backhaul terminal is greater than a preset minimum value RSRP_bh_min, and smaller than a preset maximum value RSRP_bh_max, it is possible to allow the wireless backhaul terminal to connect to the corresponding Type A base station so as to use the corresponding Type A base station as a wireless backhaul link. In other words, each of all the small cell base stations which is not set as the Type A base station may measure a RSRP of a signal coming from the Type A base station, which is already set and operating, using the wireless backhaul terminal connected thereto, and when the RSRP is in a certain range, the each of the small cell base stations may allow the wireless backhaul terminal to connect to the corresponding Type A base station and may operate as a one-hop Type B base station.

When all the small cell base stations, which are possible to access the Type A base station and can be set as the one-hop Type B base station, are set as the one-hop Type B base station, the small cell base stations which are set as the one-hop Type B base station may be set and operated in an operation S55.

Each of all the small cell base stations, of which the backhaul terminal is not possible to access the Type A base station and do not operate as the one-hop Type B base station, may attempt access to the already operating one-hop Type B base station, using a wireless backhaul terminal connected thereto.

When the backhaul terminal receives a signal of the one-hop Type B base station too strongly, a problem of cell overlap may occur, and when the backhaul terminal receives a signal of the one-hop Type B base station too weakly, a problem of too slow backhaul transmission speed may occur. Therefore, with respect to a signal coming from the one-hop Type B base station, when a RSRP measured at the wireless backhaul terminal is greater than a preset minimum value RSRP_bh_min, and smaller than a preset maximum value RSRP_bh_max, it is possible to allow the wireless backhaul terminal to connect to the corresponding one-hop Type B base station so as to use the corresponding one-hop Type B base station as a wireless backhaul link. In other words, each of all the small cell base stations which are not set as the Type A base station and the one-hop Type B base station may measure a RSRP of a signal coming from the one-hop Type B base station, which is already set and operating, using the wireless backhaul terminal connected thereto, and when the RSRP is in a certain range, the each of the small cell base stations may allow the wireless backhaul terminal to access the corresponding Type A base station and may operate as a two-hop Type B base station.

The small cell base station which cannot operate as the two-hop Type B base station is determined that the installation is impossible and the installation at the corresponding position is given up. The inoperability of the small cell base station of which the installation is impossible may be solved by attempting to install the small cell base station at another position, or adding a small cell base station which can operate as the Type A base station or the one-hop Type B base station.

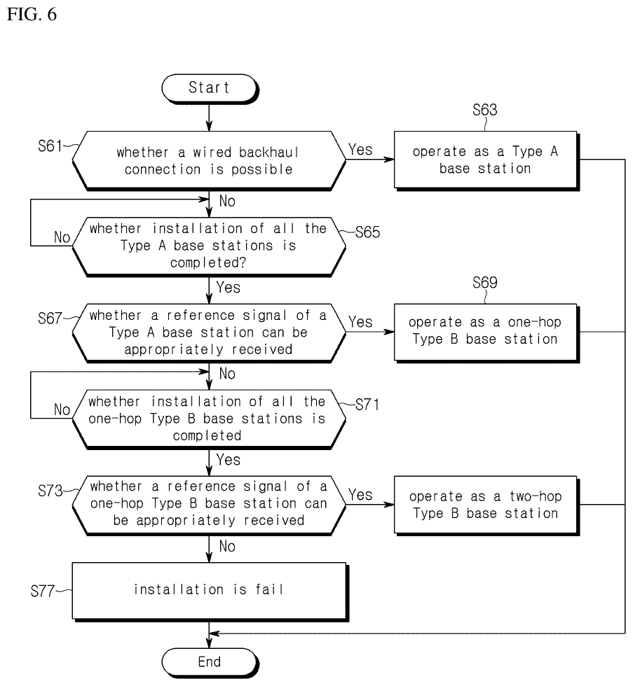

FIG. 6 is a flowchart illustrating a method of a small cell base station for selecting an own operation type.

FIG. 5 illustrates a method for installing a plurality of small cell base stations in a certain area or building, and FIG. 6 is a flowchart illustrating a method of each small cell base station, in a situation of FIG. 5, for selecting an own operation type.

Referring to FIG. 6, in an operation S61, the small cell base stations 20, 30 and 40 may determine whether the wired backhaul connection is possible. According to an embodiment, the small cell base stations 20, 30 and 40 may determine that the wired backhaul connection is possible when optical connection, WiFi connection, or Ethernet connection are implemented physically and connection to the core network is possible. In addition, the small cell base stations 20, 30 and 40 may determine that the wired backhaul connection is not possible when any one among the optical connection, WiFi connection, and Ethernet connection, which make the wired connection possible, is not implemented, or connection to the core network is not implemented.

In the operation S61, when the small cell base stations 20, 30 and 40 determine that the wired backhaul connection is possible, the small cell base stations 20, 30 and 40 proceed to an operation S63, and may operate as Type A base stations having the wired backhaul.

In the operation S61, when the small cell base stations 20, 30 and 40 determine that the wired backhaul connection is not possible, the small cell base stations 20, 30 and 40 proceed to an operation S65, and determine whether installation of all the Type A base stations is completed. For example, in a situation of installing a plurality of small cell base stations to make 5G communication possible within a building, when all the small cell base station available to perform the wired backhaul connection are connected to the wired backhaul, connected to the core network, and are set to operate as the Type A base station, it may be determined that setting of all the Type A base stations is completed and the small cell base stations operate as the Type A base station.

According to another embodiment, although all the Type A base stations are not installed, the small cell base stations 20, 30 and 40 which failed in the wired backhaul connection may determine whether there is a base station operating as the Type A base station around, by operating the backhaul terminal. When the base stations operating as the Type A base station equal to or more than a preset quantity exist nearby, the small cell base stations 20, 30 and 40 may determine that installation of all the Type A base stations is completed. In this case, detecting presence of reference signals coming from nearby base stations by the backhaul terminal is sufficient, and when the quantity of the reference signals detected is equal to or more than the preset quantity, the small cell base stations 20, 30 and 40 may determine that installation of all the Type A base stations is completed.

In an operation S67, the small cell base stations 20, 30 and 40 which failed in the wired backhaul connection may determine whether they can appropriately receive a reference signal of the Type A base station.

When the small cell base stations 20, 30 and 40 fail in the wired backhaul connection and do not operate as the Type A base station, the base stations 20, 30 and 40 may receive a reference signal of the Type A base station which operates using the wireless backhaul terminal connected thereto, and may measure a RSRP.

When the backhaul terminal receives the signal of the Type A base station too strongly, a problem of cell overlap may occur, and when the backhaul terminal receives the signal of the Type A base station too weakly, a problem of too slow backhaul transmission speed may occur. Therefore, with respect to the signal coming from the Type A base station, the small cell base stations 20, 30 and 40 may determine whether the RSRP measured at the wireless backhaul terminal is between the preset minimum value RSRP_bh_min and the preset maximum value RSRP_bh_max, and when the RSRP measured is therebetween, the small cell base stations 20, 30 and 40 may determine that the reference signal of the Type A base station is appropriately received. Then, in an operation S69, the small cell base stations 20, 30 and 40 may make the wireless backhaul terminal access the Type A base station which transmitted the reference signal, and may operate as the one-hop Type B base stations.

In the operation S67, when the small cell base stations 20, 30 and 40 determine that they cannot appropriately receive the reference signal of the Type A base station, the small cell base stations 20, 30 and 40 may determine whether installation of all the one-hop Type B base stations is completed in an operation S71. For example, each of the small cell base stations 20, 30 and 40 may receive a message indicating that the installation of all the one-hop Type B base stations is completed from an installation manager or a terminal of the installation manager, and make the determination as to whether the installation is done.

According to another embodiment, even if all the one-hop Type B base stations are not installed, the small cell base stations 20, 30 and 40 may determine whether the base stations operating as the one-hop Type B base station exist nearby by operating the backhaul terminal. When the base stations operating as the one-hop Type B base station equal to or more than a preset quantity exist nearby, the small cell base stations 20, 30 and 40 may determine that installation of all the one-hop Type B base stations is completed. In this case, detecting presence of reference signals coming from nearby base stations by the backhaul terminal is sufficient, and when the quantity of the reference signals detected is equal to or more than the preset quantity, the small cell base stations 20, 30 and 40 may determine that installation of all the one-hop Type B base stations is completed.

When it is determined that installation of all the one-hop Type B base stations is completed, in an operation S73, the small cell base stations 20, 30 and 40 which failed in operating as the one-hop Type B base stations may determine whether they can appropriately receive a reference signal of the one-hop Type B base stations.

The small cell base stations 20, 30 and 40 failed in operating as the one-hop Type B base stations may receive the reference signal of the one-hop Type B base station which operates using the wireless backhaul terminal connected thereto, and may measure a RSRP.

When the backhaul terminal receives the signal of the one-hop Type B base station too strongly, a problem of cell overlap may occur, and when the backhaul terminal receives the signal of the one-hop Type B base station too weakly, a problem of too slow backhaul transmission speed may occur. Therefore, with respect to the signal coming from the one-hop Type B base station, the small cell base stations 20, 30 and 40 may determine whether the RSRP measured at the wireless backhaul terminal is between the preset minimum value RSRP_bh_min and the preset maximum value RSRP_bh_max, and when the RSRP measured is therebetween, the small cell base stations 20, 30 and 40 may determine that the reference signal of the one-hop Type B base station is appropriately received. Then, in an operation S75, the small cell base stations 20, 30 and 40 may make the wireless backhaul terminal access the one-hop Type B base station which transmitted the reference signal, and may operate as the two-hop Type B base stations.

In the operation S73, when the small cell base stations 20, 30 and 40 determine that they cannot appropriately receive the reference signal of the one-hop Type B base station, the small cell base stations 20, 30 and 40 may determine that installation is impossible, and may send an alarm to the installation manager, or may display that installation is impossible in their own display devices in an operation S77.

According to an embodiment, the small cell base stations 20, 30 and 40 which failed in operating as the two-hop Type B base station may become operable in the end by repeatedly applying the above-described method of increasing the number of hops, however, there is a problem in that performance and efficiency may decline as the number of hops increases.

In case where the small cell base stations are installed in methods described in FIGS. 5 and 6, in order to avoid the interference, it is necessary to have a difference in the TDD patterns between the Type A base station and the one-hop Type B base station, and between the one-hop Type B base station and the two-hop Type B base station. In general, by making a downlink (DL) transmission time and an uplink (UL) transmission time be configured to be the same in the TDD pattern where downlink (DL) transmission and uplink (UL) transmission are repeated, and making the time point to start the downlink transmission between the Type A base station and the one-hop Type B base station be different by as much as a half of a repeat cycle, that is, by as much as a the downlink transmission time or the uplink transmission time, it may be possible to make a downlink transmission ratio to an uplink transmission ratio of each base station be similarly maintained while solving the interference problem due to the wireless backhaul. In addition, by setting as the above, the Type A base station and the one-hop Type B base station may start the downlink transmission at the same time, and the one-hop Type B station may be configured to start the downlink transmission before or after a time to start the uplink transmission by the Type A base station.

As described above, when connected to the core network using the wireless backhaul, the base station using the wireless backhaul must check whether the base station itself is connected to the Type A base station, which is connected to the wired backhaul of a final stage, through the relay. To this end, the base station must appropriately set a base station parameter BH_connected, which may inform that the base station is finally connected to the wired backhaul through the relay, and must respond to a request to provide the information by a neighboring base station, which is connected through the wireless backhaul terminal.

According to an embodiment, the Type A base station, which is connected to the wired backhaul may set the base station parameter BH_connected as 1 when the Type A base station is connected to the wired backhaul and starts operation. Thereafter, all the backhaul terminals may attempt access only to a base station, of which the corresponding parameter BH_connected is set as 1.

In addition, the small cell base stations may appropriately set access barring information so that the backhaul terminal connected to the corresponding small cell base station is prevented from accessing the corresponding small cell base station itself.

Although preferred embodiments of the present invention have been disclosed for illustrative purposes, those skilled in the art will appreciate that diverse variations and modifications are possible through addition, alteration, deletion, etc. of elements, without departing from the spirit and scope of the invention, and all variations or modifications are intended to be included in the scope of the present invention.

What is claimed is:

1. A method of operating a plurality of small cell base stations to support a 5G communication service, the method comprising:
operating, by all small cell base stations possible to perform a wired backhaul connection among a plurality of small cell base stations, as Type A base stations; and
operating, by all small cell base stations possible for accessing the Type A base station through a wireless backhaul terminal among the plurality of small cell base stations, as one-hop Type B base stations.

2. The method of claim 1, further comprising:
operating, by all small cell base stations possible for accessing the one-hop Type B base station through a wireless backhaul terminal among the plurality of small cell base stations, as two-hop Type B base stations: and
setting, by small cell base stations which do not belong to the Type A base station, the one-hop Type B base station, and the two-hop Type B base station among the plurality of small cell base stations, as uninstallable small cell base stations.

3. The method of claim 2,
wherein the operating by all small cell base stations possible to perform a wired backhaul connection among a plurality of small cell base stations as Type A base stations comprises:
determining, by each of the plurality of small base stations, whether the each of the plurality of small cell base stations are possible to perform a wired backhaul connection; and
setting, by each of the plurality of small cell base stations determined to be possible to perform a wired backhaul connection to operate, as Type A base stations.

4. The method of claim 2,
wherein the operating, by all small cell base stations possible for accessing the Type A base station through a wireless backhaul terminal among the plurality of small cell base stations, as one-hop Type B base stations comprises:
receiving, by each of the small cell base stations which do not operate as the Type A base station among the plurality of small cell base stations, a reference signal sent from at least one of the Type A base stations using a wireless backhaul terminal;
determining, by each of the small cell base stations which do not operate as the Type A base station among the plurality of small cell base stations, whether at least one among RSRPs (reference signals received power) of the reference signal received from at least one of the Type A base stations is in a preset range;
accessing, by each of the small cell base stations which do not operate as the Type A base station and at least one among RSRPs of the received reference signal is in a preset range, a Type A base station which sent a reference signal indicating a RSRP in a preset range using the wireless backhaul terminal; and
operating, by each of the small cell base stations which accesses a Type A base station using the wireless backhaul terminal, as the one-hop Type B base station.

5. The method of claim 4,
wherein the operating, by all small cell base stations possible for accessing the one-hop Type B base station through a wireless backhaul terminal among the plurality of small cell base stations, as two-hop Type B base stations comprises:
receiving, by each of the small cell base stations which do not operate as the Type A base station and the one-hop Type B base station among the plurality of small cell base stations, a reference signal sent from at least one of the one-hop Type B base stations using a wireless backhaul terminal;
determining, by each of the small cell base stations which do not operate as the Type A base station and the one-hop Type B base station among the plurality of small cell base stations, whether at least one among RSRPs of a reference signal received from at least one of the one-hop Type B base stations is in a preset range;
accessing, by each of the small cell base stations which do not operate as the Type A base station and the one-hop Type B base station and at least one among RSRPs of the received reference signal is in a preset range, the one-hop Type B base station which sent a reference signal indicating a RSRP in a preset range using the wireless backhaul terminal; and
operating, by each of the small cell base station which accesses a one-hop Type B base station using the wireless backhaul terminal, as the two-hop Type B base station.

6. The method of claim 2,
wherein the operating, by all small cell base stations possible for accessing the Type A base station through a wireless backhaul terminal among the plurality of small cell base stations, as one-hop Type B base stations comprises:
receiving, by each of the small cell base stations which do not operate as the Type A base station among the plurality of small cell base stations, a reference signal sent from at least one of the Type A base stations using a wireless backhaul terminal;
determining, by each of the small cell base stations which do not operate as the Type A base station among the plurality of small cell base stations, whether at least one among RSRPs of a reference signal received from at least one of the Type A base stations is in a preset range and whether a base station parameter comprised in the reference signal indicates that a wired backhaul connection is done;
accessing, by each of the small cell base stations which do not operate as the Type A base station, RSRP of the received reference signal from a first Type A base station is in a preset range and a base station parameter comprised in the received reference signal from the first Type A base station indicates that a wired backhaul connection is done, the first Type A base station using the wireless backhaul terminal; and
operating, by each of the small cell base station which accesses the first Type A base station using the wireless backhaul terminal, as the one-hop Type B base station.

7. The method of claim 6,
wherein the operating, by all small cell base stations possible for accessing the one-hop Type B base station through a wireless backhaul terminal among the plurality of small cell base stations, as two-hop Type B base stations comprises:
receiving, by each of the small cell base stations which do not operate as the Type A base station and the one-hop Type B base station among the plurality of small cell base stations, a reference signal sent from at least one of the one-hop Type B base stations using a wireless backhaul terminal;
determining, by each of the small cell base stations which do not operate as the Type A base station and the one-hop Type B base station among the plurality of small cell base stations, whether at least one among RSRPs of a reference signal received from at least one of one-hop Type B base stations is in a preset range and whether a base station parameter comprised in the reference signal indicates that a wired backhaul connection is done;
accessing, by each of the small cell base stations which do not operate as the Type A base station, RSRP of the received reference signal from a first one-hop Type B base station is in a preset range and a base station parameter comprised in a reference signal received from the first one-hop Type B base station indicates that a wired backhaul connection is done, the first one-hop Type B base station using the wireless backhaul terminal; and
operating, by each of the small cell base station which accesses the first one-hop Type B base station using the wireless backhaul terminal as the two-hop Type B base station.

8. The method of claim 5,
wherein small cell base stations operating as the Type A base stations and the two-hop Type B base stations are set to use an identical first TDD (time division duplex) pattern for downlink data transmission and uplink data transmission, and
wherein small cell base stations operating as the one-hop Type B base stations are set to use a second TDD pattern, which indicates uplink data transmission when the first TDD pattern indicates downlink data transmission, and which indicates downlink data transmission when the first TDD pattern indicates uplink data transmission.

9. The method of claim 7,
wherein small cell base stations operating as the Type A base stations and the two-hop Type B base stations are set to use an identical first TDD (time division duplex) pattern for downlink data transmission and uplink data transmission, and
wherein small cell base stations operating as the one-hop Type B base stations are set to use a second TDD pattern, which indicates uplink data transmission when the first TDD pattern indicates downlink data transmission, and which indicates downlink data transmission when the first TDD pattern indicates uplink data transmission.

10. A method for setting an operation type of a small cell base station, the method comprising:
determining whether a wired backhaul connection is possible;
setting, when a wired backhaul connection is possible, the small cell base station to operate as a Type A base station;
receiving, when a wired backhaul connection is not possible, a first reference signal of a small cell base station operating as a Type A base station using a connected wireless backhaul terminal;
determining whether RSRP (reference signals received power) of the received first reference signal is in a preset range;
setting, when RSRP of the received first reference signal is in a preset range, the small cell base station to operate as a one-hop Type B base station;
receiving, when RSRP of the received first reference signal is out of a preset range, a second reference signal of a base station operating as a one-hop Type B base station using the connected wireless backhaul terminal;
determining whether RSRP of the received second reference signal is in a preset range; and
setting, when RSRP of the received second reference signal is in a preset range, the small cell base station to operate as a two-hop Type B base station.

11. A method for setting an operation type of a small cell base station, the method comprising:
determining whether a wired backhaul connection is possible;
setting, when a wired backhaul connection is possible, the small cell base station to operate as a Type A base station;
receiving, when a wired backhaul connection is not possible, a first reference signal of a small cell base station operating as a Type A base station using a connected wireless backhaul terminal;
determining whether RSRP (reference signals received power) of the received first reference signal is in a preset range and whether a first base station parameter comprised in the first reference signal indicates that a wired backhaul connection is done;
setting, when RSRP of the received first reference signal is in a preset range and the first base station parameter indicates that a wired backhaul connection is done, the small cell base station to operate as a one-hop Type B base station;
receiving, when RSRP of the received first reference signal is out of a preset range or the base station parameter indicates that a wired backhaul connection is not done, a second reference signal of a base station operating as a one-hop Type B base station using the connected wireless backhaul terminal;
determining whether RSRP of the received second reference signal is in a preset range and whether a second base station parameter comprised in the second reference signal indicates that a wired backhaul connection is done; and
setting, when RSRPs of the received second reference signal is in a preset range and the second base station parameter indicates that a wired backhaul connection is done, the small cell base station to operate as a two-hop Type B base station.
